(19) United States
(12) Patent Application Publication
(10) Pub. No.: US 2021/0025716 A1
(43) Pub. Date: Jan. 28, 2021

(54) NAVIGATION BASED ON MULTI-AGENT INTEREST DIFFUSION

(71) Applicant: THALES, COURBEVOIE (FR)

(72) Inventors: Loïc GIGOMAS, MERIGNAC (FR); Aurélien THIRIET, MERIGNAC (FR); Nicolas DUMORTIER, MERIGNAC (FR); Guillaume DUPONT, MERIGNAC (FR)

(21) Appl. No.: 16/936,363

(22) Filed: Jul. 22, 2020

(30) Foreign Application Priority Data
Jul. 25, 2019 (FR) 1908417

(51) Int. Cl. G01C 21/20; G08G 5/00

(52) U.S. Cl. CPC G01C 21/20; G08G 5/006; G08G 5/0039

(57) ABSTRACT

A route calculation for an aircraft is provided. The invention is based on defining grids representing an environment between at least one aircraft and at least one target point. The cells of the grid define absorption levels associated with the capability of the aircraft to cross a cell, making it possible in particular to define regions that are strictly inaccessible and regions for which penetration is tolerated. An interest level is diffused from at least one target point up to the position of the aircraft. When the interest reaches the aircraft, route segments are constructed iteratively between the aircraft and the target point, by going through those cells for which the interest is highest, and then the route is simplified for sending to a flight management system in order to be converted into a trajectory followed by the aircraft.

### CROSS-REFERENCE TO RELATED APPLICATIONS

This application claims priority to foreign French patent application No. FR 1908417, filed on Jul. 25, 2019, the disclosure of which is incorporated by reference in its entirety.

### FIELD OF THE INVENTION

The present invention relates to the field of navigation and more particularly to calculating routes that allow a target point to be reached while avoiding regions and taking the flight performance of an aircraft and an angle of arrival into account.

### BACKGROUND

Aircraft, for example helicopters, have to be able to carry out extremely varied missions with a reduced crew. The missions may be any type of mission in which the aircraft needs to reach a point, for example sea or mountain rescue missions, or missions for resupplying an offshore oil rig.

In order to perform a mission, the aircraft has to follow a route from the initial position of the aircraft to a target position. This route has to take a certain number of constraints into account, such as:
the flight performances of the aircraft: the route must remain flyable in the flight envelope of the aircraft, for example by observing its minimum radius of curvature;
avoiding regions: for example, regions delimited by relief constraints, or any other region chosen by the pilot for his mission;
constraints on the approach to an objective: depending on the missions, the approach to certain objectives may be associated with certain constraints. For example, the angle of approach to an airport or an offshore oil rig may be constrained by local weather conditions, for example the wind direction. The angle of approach to the target point may also be constrained by the need for the pilot to see the target from a certain angle so as to be able to touch down directly.

In flight, the pilots of an aircraft have a certain number of piloting aids at their disposal, such as sensors, or screens allowing them to view the position of the aircraft and the route followed.

Currently, the route is determined in the mission preparation phase, and the route followed is updated manually by the pilot by modifying the route. The determined route may be sent to an FMS which will be responsible for automatically following this route.

The last flight phase is performed manually by the pilot. For example, in the context of a mission for rescuing a mountaineer or for resupplying an offshore rig, the approach to the target point is performed manually.

This solution has several drawbacks:

First, the mission takes a long time to prepare, since the pilot of the aircraft must not only define the objective of the mission, but also the entire route, while taking a potentially large number of constraints into account. This may be particularly detrimental to missions in which timing is critical, such as rescuing mountaineers in the mountains.

There is also a risk of the route that is retained not being optimal, due to the number of parameters to be taken into account, such as the fuel consumption of the aircraft, the performance of the aircraft, changes in the regions to avoid and the possible movement of the objective.

Next, the need for the pilot to adjust the route in real time over the course of the mission, in addition to following it and the set of tasks incumbent upon them, may be extremely complex and negatively affect mission performance while burdening the pilot with an excessive workload. This is especially true in the case of an environment in which the distribution of the regions to avoid changes quickly, for example in a region of unstable weather with storms breaking out sporadically.

The known approaches do not allow the situation to be remedied. For example, the known algorithms for determining a route with constraints, such as the D* algorithm, do not allow the flight performance of the aircraft or the characteristics of the FMS to be taken into account. Thus, a route created by such an algorithm will have a high likelihood of not being accepted by the FMS, because it does not allow the maximum rate of turn permitted by the aircraft to be complied with, or because it is formed of a multitude of small segments, the number of which exceeds the maximum number of segments accepted by the FMS. Additionally, the time taken for such an algorithm to calculate a route is indeterminate, and may be too long to allow the route to be calculated in real time.

There is therefore a need for a system that makes it possible to calculate, in real time, the shortest possible route for an aircraft to reach a target point while avoiding certain regions and taking the constraints on the approach to the target into account, and which is accepted by the FMS of the aircraft.

### SUMMARY OF THE INVENTION

To this end, one subject of the invention is a method for determining a route of an aircraft towards a target point in the environment of the aircraft, comprising: obtaining at least one grid representing the environment of the aircraft, a position cell of the aircraft and a position cell of the target point in the grid, the at least one grid storing, for each cell, the georeferenced positions of the four corners of the cell, an absorption coefficient defining the possibility of a trajectory of the aircraft for crossing the cells, and an interest level defining the interest for the aircraft to select a cell to reach the target point; defining, for a set of cells of the at least one grid, absorption coefficients defining the possibility of a trajectory of the aircraft for crossing the cells, according to at least one element chosen from a set of regions to avoid, trajectory initialization constraints and approach constraints; defining, for at least one cell around the target point, an interest level equal to a predefined interest threshold; a plurality of iterations, until a stop criterion is satisfied, of assigning, to each cell of the grid except said at least one cell around the target point, an interest level, equal to a weighted average of interest levels of cells in the neighbourhood of said cell, multiplied by the absorption coefficient for the cells of said set; if, upon satisfying the stop criterion, the interest level of the position cell of the aircraft is zero, activating an exit procedure; otherwise, iteratively determining a list of routing points defined by the cells having the most favourable interest level for which a straight line plotted between two successive points on the list does not cross any cell whose absorption coefficient does not allow the cell to be crossed by the aircraft; sending the list of routing points to a flight management system.

Advantageously, the grid is constructed following a rhumb line.

Advantageously, the grid has a predefined size, and the position cells of the aircraft and the position cell of the target point have predefined positions on the grid, and said method comprises a step of associating, with each cell, georeferenced coordinates according to said predefined size and positions.

Advantageously, defining, for a set of cells of the at least one grid, absorption coefficients that define the possibility of a trajectory of the aircraft for crossing the cells, comprises defining, around the position of the aircraft, an ellipse of cells according to a maximum angle of curvature of the aircraft exhibiting an absorption coefficient that prevents the diffusion of the interest into the set of cells which is incised in the direction of movement or of takeoff of the aircraft.

Advantageously, defining absorption coefficients comprises defining, around the position of the target point, an ellipse of cells exhibiting an absorption coefficient that is higher than or equal to a predefined threshold, in which at least one incision is made in the direction of at least one sector of incidence for approaching the target point.

Advantageously, the at least one cell around the target point, for which an interest level is defined that is equal to a predefined interest threshold, comprises all of the cells of the at least one incision.

Advantageously, defining absorption coefficients comprises defining, for a set of cells of which at least one of the corners is located in a region to be avoided, an absorption coefficient that is higher than or equal to a predefined threshold.

Advantageously, the stop criterion is satisfied if at least one condition is met from among the following conditions: the interest level of the position cell of the aircraft is higher than zero; the number of iterations performed is smaller than or equal to a predefined maximum iteration threshold.

Advantageously, the operation of iteratively determining a list of routing points is performed by initializing the list with the position of the aircraft and, for as long as the at least one cell around the target point has not been reached, determining a next point, on the basis of the current routing point on the list, by: making a selection of a first candidate cell as the cell in the neighbourhood of the current routing point exhibiting the most favourable interest level; selecting a second candidate cell as the cell in the neighbourhood of the first candidate cell exhibiting the most favourable interest level; checking for the presence of a cell that cannot be crossed by the aircraft between the second candidate cell and the current routing point; if a cell that cannot be crossed by the aircraft is present between the second candidate cell and the current routing point: adding the first candidate cell to the list as the current routing point; returning to selecting the first candidate cell; if no cell that cannot be crossed by the aircraft is present between the second candidate cell and the current routing point: replacing the first candidate cell with the second candidate cell; returning to the step of selecting a second candidate cell.

Advantageously, the operation of sending the list of routing points to the flight management system comprises: converting the list of routing points defined by cells in a list of georeferenced positions obtained, respectively, through linear interpolation of the georeferenced positions of the corners of the cells; sending the list of georeferenced positions to the flight management system.

Another subject of the invention is a computer program comprising program code instructions stored on a computer-readable medium for determining a route of an aircraft towards a target point in the environment of the aircraft when said program is run on a computer, said program code instructions being configured for: obtaining at least one grid representing the environment of the aircraft, a position cell of the aircraft and a position cell of the target point in the grid, the at least one grid storing, for each cell, the georeferenced positions of the four corners of the cell, an absorption coefficient defining the possibility of a trajectory of the aircraft for crossing the cells, and an interest level defining the interest for the aircraft to select a cell to reach the target point; defining, for a set of cells of the at least one grid, absorption coefficients defining the possibility of a trajectory of the aircraft for crossing the cells, according to at least one element chosen from a set of regions to avoid, trajectory initialization constraints and approach constraints; defining, for at least one cell around the target point, an interest level equal to a predefined interest threshold; performing a plurality of iterations, until a stop criterion is satisfied, of assigning, to each cell of the grid except said at least one cell around the target point, an interest level, equal to a weighted average of interest levels of cells in a neighbourhood of said cell, multiplied by the absorption coefficient for the cells of said set; if, upon satisfying the stop criterion, the interest level of the position cell of the aircraft is zero, activating an exit procedure; otherwise, iteratively determining a list of routing points defined by the cells having the most favourable interest levels for which a straight line plotted between two successive points on the list does not cross any cell whose absorption coefficient does not allow the cell to be crossed by the aircraft; sending the list of routing points to a flight management system.

Another subject of the invention is a system for managing a mission of an aircraft comprising computing means for determining a route of the aircraft towards a target point in the environment of the aircraft, said computing means being configured for: obtaining at least one grid representing the environment of the aircraft, a position cell of the aircraft and a position cell of the target point in the grid, the at least one grid storing, for each cell, the georeferenced positions of the four corners of the cell, an absorption coefficient defining the possibility of a trajectory of the aircraft for crossing the cells, and an interest level defining the interest for the aircraft to select a cell to reach the target point; defining, for a set of cells of the at least one grid, absorption coefficients defining the possibility of a trajectory of the aircraft for crossing the cells, according to at least one element chosen from a set of regions to avoid, trajectory initialization constraints and approach constraints; defining, for at least one cell around the target point, an interest level equal to a predefined interest threshold; performing a plurality of iterations, until a stop criterion is satisfied, of assigning, to each cell of the grid except said at least one cell around the target point, an interest level, equal to a weighted average of interest levels of cells in the neighbourhood of said cell, multiplied by the absorption coefficient for the cells of said set; if, upon satisfying the stop criterion, the interest level of the position cell of the aircraft is zero, activating an exit procedure; otherwise, iteratively determining a list of routing points defined by the cells having the most favourable interest levels for which a straight line plotted between two successive points on the list does not cross any cell whose absorption coefficient does not allow the cell to be crossed by the aircraft; sending the list of routing points to a flight management system.

The invention makes it possible to generate, in real time, the shortest possible aircraft routes from the position of an aircraft to the position of a target point while avoiding certain regions and taking the constraints on the approach to the target point into account, the routes complying with the flight capabilities of the aircraft in order to be flyable and accepted by the FMS of the aircraft.

The invention thus makes it possible to define and update an aircraft route that automatically takes all of the mission constraints into account in real time, which considerably reduces the workload on the pilot.

The invention is capable of supplying routes to existing FMSs. Additionally, the input data required for determining a route may be obtained using the equipment, for example the sensors, that are usually present in an aircraft. The invention is therefore compatible with existing aircraft equipment and these FMSs, and may easily be deployed in existing systems.

The invention is capable of defining a plurality of starting points, corresponding to a plurality of aircraft able to perform the mission, and to automatically select that for which the route is shortest.

The invention requires limited computing power, allowing rapid execution using onboard computing capabilities. Additionally, the computing time may be limited according to certain input parameters such as the size of the grid and the maximum number of iterations of diffusion. This therefore makes it possible to calculate the route of the aircraft almost in real time.

### BRIEF DESCRIPTION OF THE DRAWINGS

Other features, details and advantages of the invention will become apparent upon reading the description provided with reference to the appended drawings, which are given by way of example and show, respectively:

FIG. 1, an avionics architecture in which the invention may be implemented;

FIG. 2, a schematic representation of an environment and a mission trajectory in a set of embodiments of the invention;

FIG. 3, an exemplary method for determining a route of an aircraft according to a set of embodiments of the invention;

FIGS. 4a to 4j, exemplary steps in calculating routes for aircraft calculated in the implementation of the invention; and

FIG. 5 an exemplary aircraft route calculated in an embodiment of the invention.

### DETAILED DESCRIPTION

Certain acronyms commonly used in the technical field of the present application might be employed in the course of the description. These acronyms are listed in the table hereinbelow, with notably the corresponding term and meaning.

TABLE 1

| Acronym | Term | Meaning |
|---|---|---|
| ARINC | Aeronautical | Company held by major American aerospace |
| | Radio, | players known for defining the main |
| | Incorporated | communication standards inside aircraft and |
| | | between aircraft and the ground. |
| | | Refers both to the company and to the |
| | | standards produced, for example the |
| | | ARINC 429 and ARINC 661 standards. |
| FMS | Flight | Computerized system for calculating aircraft |
| | management | trajectories and routes, and for supplying |
| | system | suitable guide instructions for the pilot or |
| | | autopilot to follow the trajectory calculated. |
| MMS | Mission | Mission system allowing the pilot of an |
| | management | aircraft to monitor the mission of the aircraft. |
| | system | |

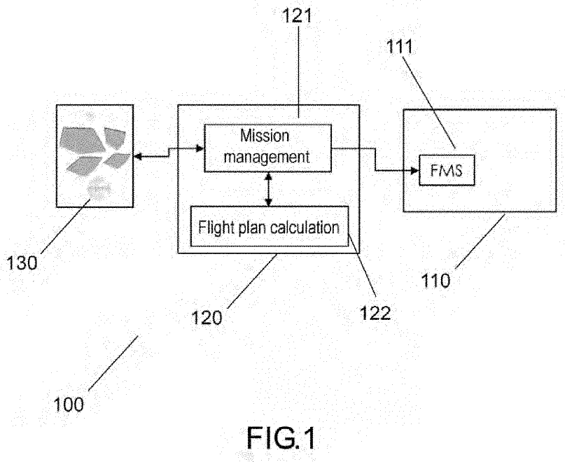

The FIG. 1 represents an avionics architecture in which the invention may be implemented.

The avionics architecture 100 is an avionics architecture that may be deployed in an aircraft. One of the aims of the invention is to provide the crew, in real time, assistance and automation functions for carrying out the mission. The avionics architecture 100 is in particular capable of being deployed in an aircraft, typically a helicopter, with a reduced crew. In general, the invention may be deployed using the resources that are usually present in an aircraft so as not to increase the weight of onboard systems, and in order to observe the certification constraints of the platform.

In terms of resources, a mission aircraft comprises various elements.

An aircraft may embed equipment which allow it to carry out its mission, such as sensors. For example, the aircraft may include an infrared camera for use in search and rescue missions.

It also comprises a human-system interface (HSI) 130 allowing the pilot to interact with the equipment of the aircraft, for example by displaying information to them, and allowing them to enter information or instructions. The HSI 130 may comprise any and all types of equipment capable of supplying information to the pilot. For example, it may comprise screens, but also loudspeakers, alarms, warning light signals, etc. Similarly, it may comprise various items of equipment allowing the pilot to enter their instructions: touchscreens, keyboards, microphone, etc.

It also comprises an avionics system 110, in particular an FMS 111. The ARI NC 702 standard describes the various functions of FMSs. In particular, the flight planning function FPLN is considered; it allows the geographical elements forming the backbone of the route to be followed, for example departure and arrival procedures, waypoints or airways, to be entered. These may be entered manually by the pilot, or automatically if the information is received from another item of equipment. The FMS 111 determines a trajectory on the basis of a list of waypoints, taking the performance of the aircraft into account (i.e. flight envelope, maximum permitted speed, minimum radius of curvature, etc.).

To this end, the FMS 111 has access to one or more databases: aircraft performance database, database of air navigation elements, etc. Once the trajectory has been calculated by the FMS 111, it may be followed, for example by transmitting the corresponding information to an autopilot, or by displaying the trajectory to the pilot for them to follow it manually. The FMS thus makes it possible to ensure that regulatory and aircraft constraints are properly observed. If the route supplied to the aircraft does not allow a valid trajectory and route to be determined, it will be rejected by the aircraft.

The architecture 100 also comprises an MMS 120, which assists the pilot in performing tasks, by providing them with dedicated functions: for example, functions for managing sensors, functions for assisting in decision-making, or functions for automating certain tasks. To this end, the MMS 120 comprises a mission management module 121. The mission management module 121 communicates with the HSI 130 in order to interact with the pilot (for example, to display a map of the environment and the data from sensors, and to receive mission instructions from the pilot, etc.) Thus, the MMS 120 makes it possible for the pilot to have relevant information at their disposal, to define the mission to be performed via the mission management module 121, and to send routes to the FMS 111 in order to calculate the trajectory of the aircraft.

The various modules presented in FIG. 1 may be run on different types of onboard computers. According to various modes of implementation of the invention, the various modules may be run on the same onboard computers, or on specific computers.

In one set of embodiments of the invention, the MMS 120 comprises a module 122 for calculating a route. As will be explained below, the route calculation module 122 makes it possible to determine a route between the position of the aircraft and a target point, taking the flight performance of the aircraft, the regions to avoid and the mission constraints into account. The route calculated by the module 122 also takes certain input constraints of the FMS 111 into account. For example, a route calculated by a module 122 according to the invention limits the number of waypoints used to describe the trajectory, so as not to exceed the maximum number of waypoints that can be accessed as input by the FMS 111. Thus, one of the advantages of the invention is to make it possible to automatically calculate an optimal route, which will be accepted by the FMS 111 and will allow a valid trajectory to be calculated.

According to various embodiments of the invention, the route calculation module 122 may be run on a specific computer, but also on an existing onboard computer, for example that on which the mission management module 121 is run. In the latter case, a simple software update allows the invention to be deployed on an existing aircraft, without modifying the avionics.

The architecture 100 corresponds to an avionics architecture, in which a pilot is present in the aircraft. However, it is given by way of example only, and the invention is equally applicable to other types of aircraft, for example to drones. In this case, mission management may be run by receiving instructions from a remote operator, or entirely automatically.

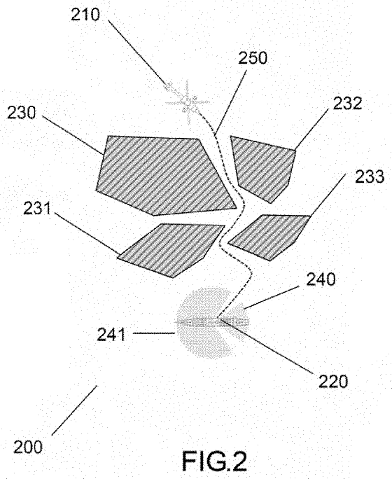

The FIG. 2 shows schematic representation of an environment and a mission trajectory in one set of embodiments of the invention.

A distinction is generally made between two types of navigation: conventional air navigation, the objective of which is to fly the aircraft while observing the constraints for General Air Traffic (GAT). These constraints are mentioned by the regulating authority: observing the regulations, observing air corridors, and, by the airline: punctuality, passenger comfort, fuel; tactical air navigation, the constraints of which are dictated by the tasks to be performed on the mission, and come from implementing the sensors and the operational tasks to be performed.

The invention aims to optimize the flight of the aircraft for the tactical part of the mission. This function makes it possible to provide the pilots with a navigation aid, which calculates and proposes routes while taking various elements in the environment of the aircraft, such as weather, fuel, sensor capabilities, or a specific flight pattern to be observed into account. It should be noted that these various constraints may occur simultaneously in a flight environment.

Advantageously, the invention takes the constraints of the FMS into account and therefore makes it possible to automate the flying of the route calculated.

The mission environment comprises the position of the aircraft 210 and the position of the target point 220. In the example of the FIG. 2, the mission is a mission consisting in touching down on a ship, for example to resupply it with provisions, medical equipment, etc. However, the invention is not restricted and may be applied to numerous missions associated with various types of target points: resupplying an oil platform, mountain rescue, maritime surveillance, etc.

The mission environment 200 comprises regions to avoid 230, 231, 232, 233. For example, such regions may be defined so as to avoid relief or dangerous weather.

The invention makes it possible to define regions that are strictly inaccessible (for example regions of relief into which the aircraft may not go under any circumstances), and regions which may allow some tolerance, the aircraft being able to enter them somewhat if it allows substantial optimization of the route (this may for example be the case with a stormy region, which the aircraft should avoid as far as possible, but into which ingress is conceivable if the route is greatly shortened as a result).

The mission environment may also comprise constraints 240, 241 on the approach to the target point. These constraints limit the way in which the target point may be approached. In the example of FIG. 2, the constraints 240, 241 correspond to an optimal landing angle for resupplying the vessel 220: arriving from the rear with optimal approach to the landing zone on the vessel. Approach constraints may be defined in numerous other cases: for example, restrictions may be defined for the angle and direction of approach to a given heliport; in the event of strong wind, the angles from which a target point may be approached may also be limited to ensure the correct approach of the aircraft, etc.

In one set of embodiments of the invention, a route, subsequently converted into a trajectory by the FMS, is calculated on the basis of these constraints. For example, the trajectory 250 corresponds to a shorter path for the aircraft to the target point, avoiding defined regions, and observing the constraints on the approach to the target point.

One of the objectives of the invention is therefore to calculate an optimal route between the aircraft and the target point, taking the set of constraints of avoiding certain regions, on approaching the target and of the performance of the aircraft and the input constraints of the FMS for calculating the trajectory into account.

One of the objectives of the invention is also to provide a fast calculation, allowing the route of the aircraft to be recalculated without delay. The route of the aircraft may thus be recalculated periodically or at the request of the pilot, in order to adjust to changes in the environment: for example, the route and the trajectory 250 may be recalculated in order to take changes in the position of the target point 220 (i.e. movement of a ship on which to touch down, updating the position of a mountaineer to be rescued if new information is received, etc.), approach constraints 240, 241 (for example in the case of change of heading of the ship on which to touch down, change in wind direction for the approach to a heliport, etc.), or regions to avoid 230, 231, 232, 233 (for example in the case of change in the position of stormy regions, etc.) into account.

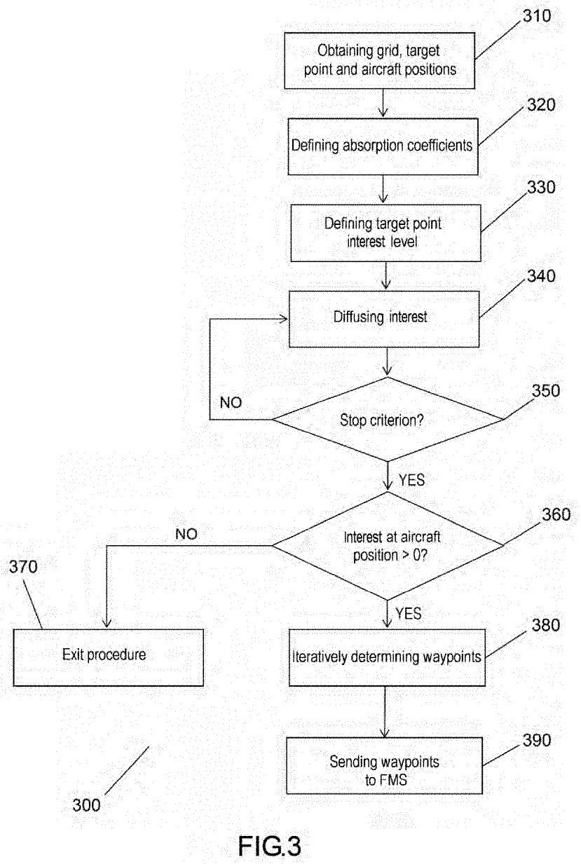

FIG. 3 shows an exemplary method for determining a route of an aircraft according to one set of embodiments of the invention.

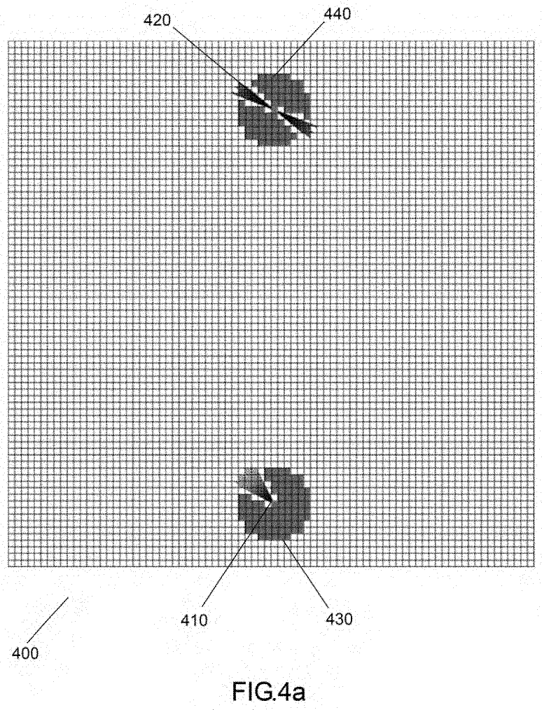

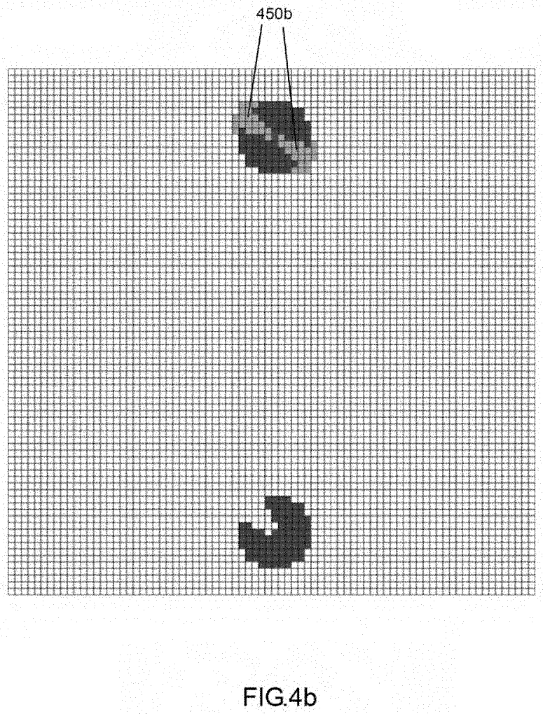

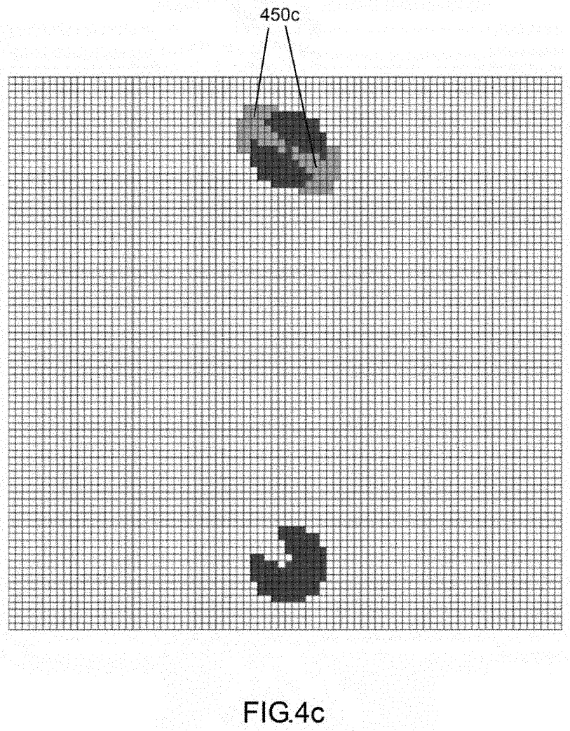

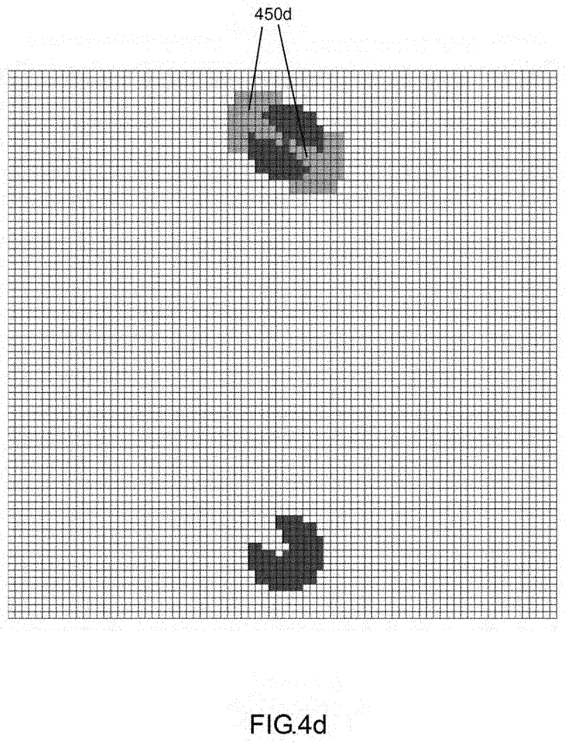

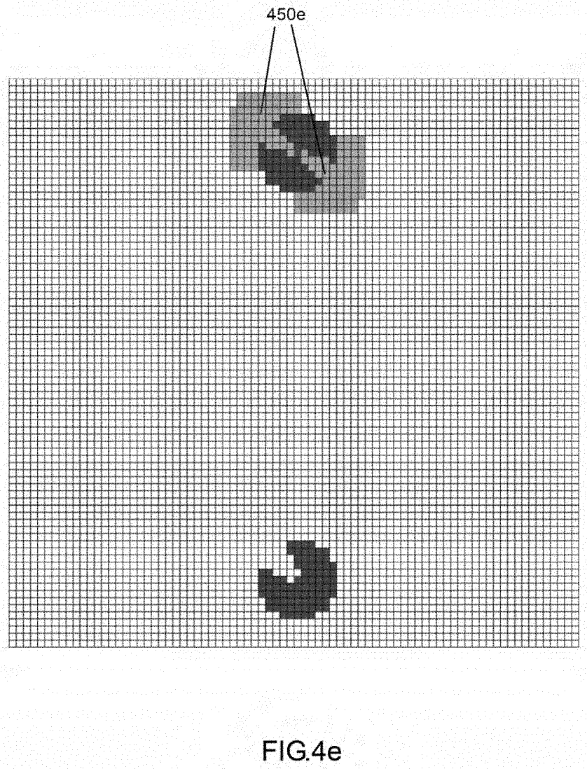

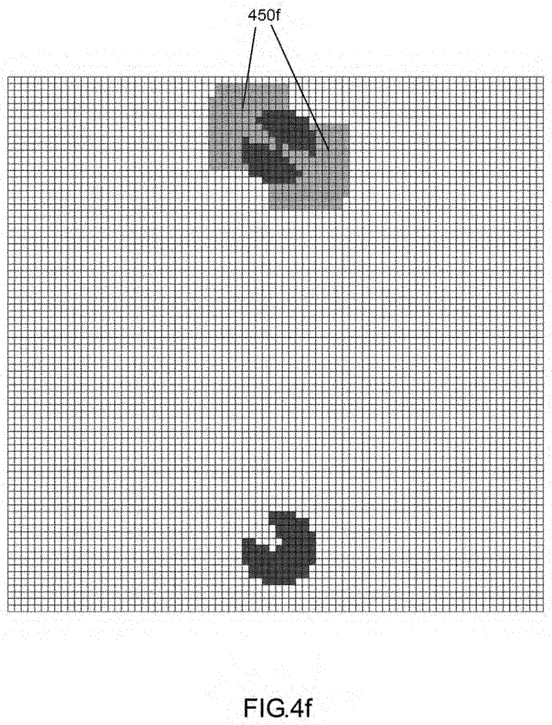

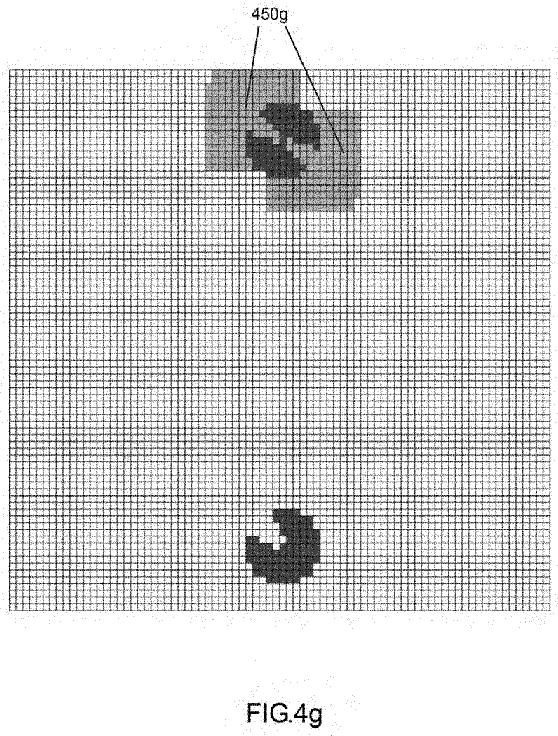

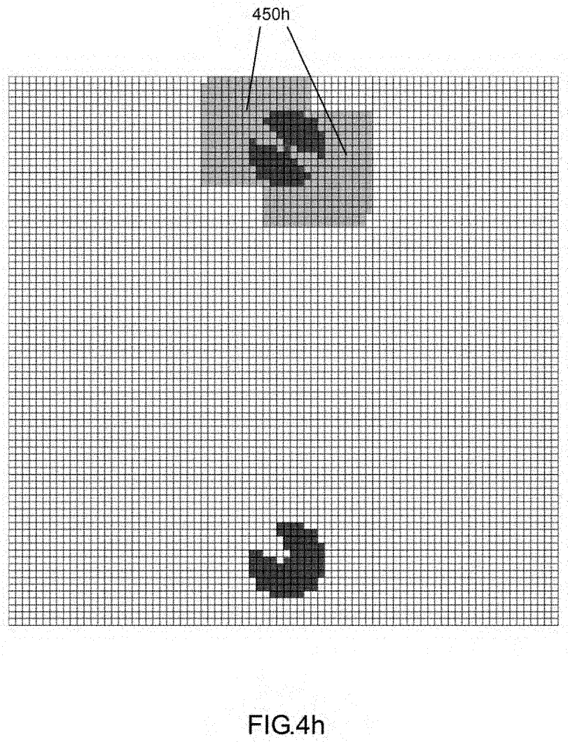

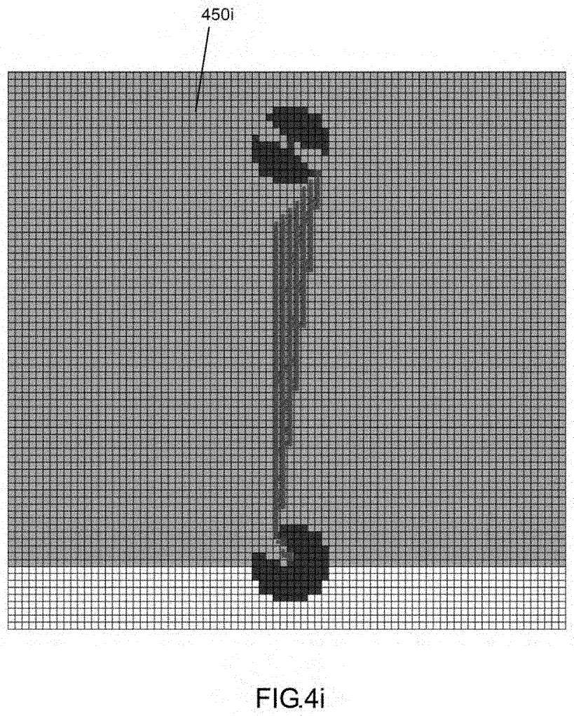

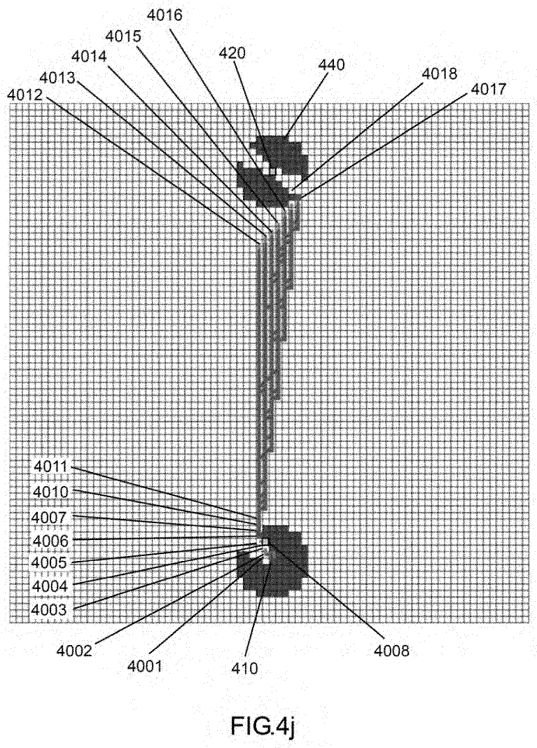

This method will be described with reference to its successive steps shown in FIG. 3, the objects handled, calculating steps and results obtained being shown in FIGS. 4a to 4j.

Some of the concepts of the invention are based on what is called the “collaborative diffusion” algorithm described by Repenning, A. (2006, October). Collaborative diffusion: programming antiobjects. In Companion to the 21st ACM SIGPLAN symposium on Object-oriented programming systems, languages, and applications (pp. 574-585). ACM. In order to represent the interest for the aircraft to move into some cells rather than others in a grid, the invention uses the following concepts introduced in this publication:
the interest: represents the interest for the aircraft to move into a given cell. The interest is maximum at the target point, and diffuses iteratively into the adjacent cells;
the absorption coefficients: define, for a given cell in a grid, the way in which the interest may or may not diffuse into it. Thus, an absorption value of one completely prevents the diffusion of the interest (and hence the movement of the aircraft into a cell), while values of zero or close to zero allow movement into the cells, the incentive to move through a given cell increasing with decreasing absorption coefficient. The absorption coefficient is, for a given cell, within the range [0; 1];
an agent is an element linked to one or more cells defining absorption coefficients and/or an interest level. “Transmitting agents” are referred to for cells whose interest level is defined by a positive value that remains fixed (the interest then diffuses from this cell), “neutral agents” or “diffusing agents” are referred to when movement through a cell is allowed (there will then be a low absorption coefficient for the interest in the corresponding cells), and “threat agents” when movement through a cell is forbidden or disadvantageous (there will then be an absorption coefficient that is high or even equal to one).

In order to facilitate the understanding of the disclosure, it will, in part, adopt the nomenclature introduced by Repenning et al. However, this nomenclature is not limiting, and the invention could be used while modifying the nomenclature and the name of concepts dealt with.

The method 300 comprises a step of obtaining 310 at least one grid 400 representing the environment 200 of a position cell of the aircraft 410 and of a position cell of the target point 420 in the grid.

The method 300 determines the route of the aircraft within a grid 400 representing the environment of the aircraft, i.e. the environment of the aircraft in which the mission takes place. The grid 400 may take various shapes; it may for example be square. The grid 400 is georeferenced, i.e. each cell of the grid is associated with at least one georeferenced position.

The grid 400, shown in FIGS. 4a to 4j, may be georeferenced in various ways. For example, each row may represent a latitude, and each column a longitude, with a constant latitude/longitude difference between the rows and columns.

For formatting reasons, FIGS. 4a to 4j show all of the values handled on a single grid. However, in one set of embodiments of the invention, a set of grids is created, with one grid per type of data handled. In this case, the corresponding cells of the grids correspond to the values of the different types of data handled, at a given point. It is thus possible to create three grids comprising, respectively, the geographical coordinates of the corners of the cells, the absorption coefficients and the interest levels for each cell, or a single grid comprising all of these data, for example with a data vector per cell. Alternatively, a grid may be defined with, for each cell, a type of agent (neutral, transmitting or threat) and an associated parameter. The invention is not restricted to a particular way of representing the data provided that, if the data are represented in a plurality of grids, there is a correspondence between the cells of the grids. In order to simplify the reading of this disclosure, reference will be made hereinafter to “the grid” or to “the at least one grid” even if the geographical coordinates, the interest levels and the absorption coefficients are placed in three different grids.

In one set of embodiments of the invention, each cell of the grid 400 of coordinates stores the coordinates (latitude and longitude) of a corner of the cell, for example the top-left corner. Thus, by adding a row and a column relative to the number of cells desired for the grid, each of the four corners of a cell in the grid is associated with geographical coordinates. It is then possible to determine, through linear interpolation of the coordinates of the four corners (assuming that the earth may be considered to be locally flat within a cell), the geographical coordinates of any point within the cell itself.

In one set of embodiments of the invention, the grid 400 is constructed following a rhumb line, i.e. the association between the cells of the grid and the geographical coordinates take the curvature of the earth into account, so that a straight line on the grid corresponds to a constant heading of the aircraft. As will be explained further below in the description, the method 300 determines the route of the aircraft as a succession of segments within the grid 400. Using a rhumb line to construct the grid therefore makes it possible to directly integrate the curvature of the earth into the calculation of the route: a shortest trajectory on the grid will also be the actual shortest trajectory of the aircraft. Additionally, a straight line on the grid will correspond to a shortest path between two points, taking the curvature of the earth into account.

In one set of embodiments of the invention, the grid 400 has a fixed size, and the position cell of the aircraft 410 and position cell of the target point 420 have a fixed location within the grid. It is then possible to deduce, from the geographical positions and location of the aircraft and of the target point on the grid, the geographical coordinates of each of the cells in the grid 400.

Using a grid of fixed size makes it possible to limit the computing time, regardless of the distance. Specifically, it will become apparent from the rest of the description that the number of operations to be performed is substantially proportional to the number of cells. Thus, using a grid of fixed size makes it possible to fix the number of cells, and hence the computing time on a given computing platform. The number of cells in the grid may therefore be predefined in order to ensure a real-time route calculation.

Additionally, this makes it possible to increase the accuracy of the route calculation as the aircraft approaches the target. Specifically, the closer the positions of the aircraft and its target, the higher the resolution of the cells, at constant grid size. The invention therefore makes it possible to recalculate an increasingly accurate route as the aircraft advances.

The applicant has noticed that a grid size of 100×100 useful cells strikes a good compromise between sufficient resolution in calculating the trajectory and limited computational complexity (this size corresponds to a size of 101×101 for a coordinate grid, using the convention according to which each cell of the grid stores the geographical coordinates of one of the corners of the cell, and that a row and a column have to be added to have all of the coordinates). In the following examples, square grids of 100×100 useful cells will be considered for the grids storing the interest levels and absorption coefficients, corresponding to 101×101 cells for the grid containing the cell corner coordinates, and the cells of the grid are numbered from 0 to 99 on a horizontal axis x and a vertical axis y. However, these grid dimensions and shape are given by way of example only, and other grid shapes and sizes may be used according to different embodiments of the invention.

In one embodiment of the invention, the aircraft and the target point are located at the bottom middle and top middle of the grid, respectively. For example, the grid 400 may be defined in the following way:
the distance between the aircraft and the target is determined; 20% is added to this distance to obtain the size of a side of the grid the positions of the aircraft and the target point on the grid are determined: x_aircraft=9, y_aircraft=50 and the target is at x_target=90, y_target=50. As shown in FIG. 4a, this makes it possible to retain the maximum number of cells possible for determining the optimal route. The grid therefore has no predefined orientation a priori. In particular, it will not necessarily be organized along a vertical north-south axis and a horizontal east-west axis;
the size of a cell segment is calculated by multiplying the distance between the aircraft and the position of the target point by a coefficient that is representative of the margin taken around the positions of the aircraft and of the target point (for example 1.2 in the preceding example to reflect the fact that the aircraft and the target are located, respectively, in the cells of vertical index 9 and 90 out of 100), and dividing by the number of cells per side (for example 100);
the position of the origin of the grid is calculated according to the position of the carrier and the carrier-target orientation using a rhumb line:
   starting from the aircraft, move a distance equivalent to the margin (10% of the size) with an angle equal to the carrier-target orientation+pi;
   next, move a distance of half of the working region with an angle equal to the carrier-target orientation—pi/2.

Other ways of obtaining the grid and the positions of the aircraft and of the target are also possible. For example, the grid may correspond to a broadened theatre of operations corresponding to cells with predefined positions, and the cells corresponding to the positions of the aircraft and of the target are selected within this grid.

The method 300 then comprises a step 320 of defining, for a set of cells of the at least one grid 400, absorption coefficients defining the possibility of a trajectory of the aircraft for crossing the cells, according to a set of regions to avoid, trajectory initialization constraints and approach constraints. This step consists in defining, for each cell that is potentially crossable by the aircraft, an absorption coefficient which, according to its value, will favour to a greater or lesser degree the movement of the aircraft through a given cell: the absorption coefficients may for example be within the range [0; 1]: a coefficient of one will completely prevent the aircraft from moving through a given cell; the smaller the coefficient, the more able the aircraft is to cross the corresponding cell. The absorption coefficients have the interest of providing a single solution that makes it possible to define the behaviour to be adopted by the aircraft according to extremely varied constraints (avoiding obstacles, angle of attack to the target, etc.). The absorption coefficients may be defined explicitly for each cell, or by defining a type of agent for each cell with, where appropriate, an associated parameter (in this case, a neutral agent will correspond to an absorption coefficient of zero, and a threat agent to a non-zero absorption coefficient).

In one set of embodiments of the invention, defining absorption coefficients comprises defining, around the position of the aircraft 410, an ellipse of cells 430 exhibiting an absorption coefficient that prevents the diffusion of the interest into the cell (i.e. a coefficient equal to one according to the nomenclature defined above), incised in the direction of movement on takeoff of the aircraft according to a maximum angle of curvature of the aircraft.

This allows the route calculated to start off in the direction of flight of the aircraft: the trajectory calculated while taking this constraint into account will necessarily start in the direction of movement of the aircraft, and, if it immediately has to make a U-turn, the U-turn will observe the maximum radius of curvature of the aircraft.

In one set of embodiments of the invention, defining the absorption coefficients comprises defining, around the position of the target point 420, an ellipse of cells 440 exhibiting an absorption coefficient that is higher than or equal to a predefined threshold, incised in the direction of at least one sector of incidence for approaching the target point.

The predefined threshold makes it possible, according to the circumstances, either to completely forbid the aircraft to cross the cells of the ellipse, or to discourage it so as to promote trajectories going through the incisions. Here, the incisions correspond to a desired sector of incidence for the approach to the target point. For example, the incisions may be determined with respect to weather conditions: they may correspond to a desired direction of arrival leeward or against the wind with respect to a given point. They may also correspond to a desired incidence of arrival with respect to a runway. In any case, this allows the aircraft to approach the target point with priority to the desired angles of incidence.

According to various embodiments of the invention, defining absorption coefficients 320 comprises defining, for a set of cells of which at least one of the corners is located in a threat, an absorption coefficient that is higher than or equal to a predefined threshold.

In one set of embodiments of the invention, various regions to avoid may be defined. They may be meteorological threats (storms, etc.), relief, regions around other aircraft flying substantially at the same altitude, or more generally any region presenting a danger to the aircraft.

These regions to avoid may be represented in various ways: they may for example be ellipses, squares or more complex shapes. A person skilled in the art will easily be able to envisage the shapes suitable for a given type of constraint, as far as this shape allows them to determine whether the geographical coordinates associated with a given corner of a cell are comprised within.

According to various embodiments of the invention, different absorption coefficients may be associated with each of these regions to avoid. For example, a relief-type threat may be associated with an absorption coefficient of one, since the aircraft must not under any circumstances collide with dangerous relief, while a coefficient smaller than one could be used for a region of low turbulence, which the aircraft could enter somewhat if necessary. A person skilled in the art could identify, according to the constraints of the region, the most suitable absorption coefficient.

In one set of embodiments of the invention, a margin may be applied to the regions to avoid prior to verifying the cells associated with the threat.

In one set of embodiments of the invention, the method takes a coefficient, called the aggressiveness coefficient, as input, which indicates at which point the aircraft may, where appropriate, enter some of the regions to avoid. The higher the aggressiveness coefficient, the smaller the margin and the lower the absorption coefficient associated with the regions to avoid. According to various embodiments of the invention, the aggressiveness coefficient may be applied to all or some of the regions to avoid. For example, it may be applied to weather-type threats, but not to relief-type threats.

In one set of embodiments of the invention, all of the cells for which an absorption coefficient indicating that the aircraft must avoid said cell (for example, as mentioned above, in order to observe the initial orientation of the aircraft, the approach to the target, or to avoid regions) has not been defined may be associated with an absorption coefficient that is favourable to the aircraft crossing a cell, for example a predefined absorption coefficient lower than those used to mark threat cells, or the ellipses around departure and arrival points. For example, an absorption coefficient of zero may be used. The term “neutral agent” is then used to refer to these cells: these cells allow interest to be diffused without absorption.

The invention then comprises a step 330 of defining, for at least one cell around the target point, an interest level equal to a predefined interest threshold. The cell will then act as a “transmitting agent”, i.e. the interest propagates from this cell, without the interest level of the cell representing the transmitting agent varying. Thus, these cells allow the interest to diffuse progressively. As will be explained below, the aircraft will tend to follow a trajectory of increasing interest up to the target point.

According to various embodiments of the invention, the one or more “transmitting agents” may be defined in various ways. For example, only the position cell of the target point 420 may be a transmitting agent.

In the embodiments in which an ellipse of cells is defined around the target point, with an incision in the direction of at least one sector of incidence for the approach to the target point, a transmitting agent may be placed in each of the cells of the incision in order to further promote a trajectory approaching the target point via the incision.

According to various embodiments of the invention, various interest values may be assigned to the transmitting agents. For example, a value equal to the width of the grid, for example 100, may be assigned to the transmitting agents.

The interest level of the cells not containing a transmitting agent is initialized to a lower value, for example zero.

The method 300 then comprises iterative steps of diffusing the interest 340.

Each iteration of diffusing the interest consists in going through all of the cells, and for each cell other than the transmitting agents (i.e. the cells other than the target point, or the cells of an incision in an ellipse around the target point), its interest is defined as a weighted average of the interest values of the cells in its neighbourhood.

Different neighbourhoods and weightings may be envisaged. For example, a Moore or von Neumann neighbourhood may be envisaged. In one set of embodiments of the invention, the interest value may be defined as the mean of the cells in the first-level Moore neighbourhood of a cell, weighted by the inverse of the Euclidean distance between the current cell and each of the cells in the neighbourhood.

This allows the interest to be diffused, i.e. the interest level of the cells, which remains fixed for the transmitting agents located close to the target point, is diffused step by step, being attenuated with increasing distance from the target point.

In the case of “threat agent”-type cells, i.e. of cells representing an obstacle, or an ellipse around the position of the aircraft or the target position, the corresponding absorption coefficient is applied by multiplying the value obtained by the weighted average by a value (1−c_{abs}), where c_{abs} is the absorption coefficient.

If the absorption coefficient is equal to one, the interest level of the cell will remain equal to zero. However, if it is between zero and one, movement through the cell will decrease the interest level more substantially than moving through a cell of neutral agent type, but will not completely cancel out the interest of moving through said cell. Thus, if moving through a cell of threat agent type assigned a moderate absorption coefficient allows a path that is much shorter than the path allowed by just the neutral agent cells, this cell may be retained for constructing the route of the aircraft. Defining the absorption coefficients therefore makes it possible to define a balance between searching for the shortest route and avoiding regions by adjusting, for each region, an absorption level which makes it possible to envisage, where appropriate, a limited incursion into it rather than completely avoiding it, if this allows sufficient gain in terms of distance traveled. This principle therefore allows a very flexible definition of the regions that the aircraft is encouraged or not encouraged to cross.

In one set of embodiments of the invention, if the iterations are numbered with an index n=1, 2, 3, . . . in each iteration of index n, the interest values previously obtained in iteration n−1 are stored, and, for the diffusion of the interest 340, the weighted averages are taken from the interest values stored upon completion of iteration n−1, in order to avoid a bias in the diffusion (i.e. to avoid an interest value in iteration n being calculated as a weighted average of the interest values of surrounding cells, from both iteration n and n−1). This may be done for example by duplicating the grid of interest values before diffusion, or by storing the interest values in iteration n in a blank grid, which will replace the current grid once the iteration has ended.

A plurality of iterations of diffusing the interest 340 are carried out until a stop criterion is satisfied 350.

The stop criterion makes it possible to determine the moment when the number of iterations is considered to be sufficient.

In one set of embodiments of the invention, the stop criterion is satisfied when the interest at the position cell of the aircraft 410 is higher than zero. This effectively means that a path has been found to the aircraft. Additionally, it may be considered that the first path found is highly likely to be the shortest and hence the best. Other criteria relating to the interest at the aircraft are possible: for example, the stop criterion may be satisfied after a predefined number of iterations once the interest at the position of the aircraft has become non-zero, when the interest at the aircraft is below a predefined threshold, and the difference in interest between two iterations has become sufficiently low. Thus, any stop criterion reflecting the fact that a satisfactory path has been found between the aircraft and the target point may be used.

In one set of embodiments of the invention, the stop criterion is satisfied if a predefined maximum number of iterations is reached. This number may for example be equal to 10 times the number of cells on the side of the grid, i.e. 1000 if the grid includes 100 cells. This maximum number of iterations may thus be chosen such that, if this number is reached and the interest level at the position cell of the aircraft is still zero (i.e. if no path has been identified between the aircraft and the target point), it is highly likely that no path exists between the aircraft and the target.

These conditions may be combined: thus, the stop criterion may be realized if the interest level of the position cell of the aircraft 410 is higher than zero, or if the number of iterations performed is smaller than or equal to a predefined maximum number of iterations.

The method 300 then comprises checking 360 whether the interest at the position cell of the aircraft 410 is zero. As mentioned above, this means that no path between the aircraft and the target point has been found within the constraints present.

In this case, an exit procedure 370 is activated. This exit procedure may be of various kinds. It may for example comprise a visual or acoustic warning message. It may also comprise, via the mission management interface 121 and the HMI 130, an invitation for the pilot to modify the calculating parameters. Specifically, different calculating parameters may make it possible to find a path, for example by decreasing the absorption coefficients of threats, or by increasing the aggressiveness level in the embodiments that take this parameter into account. The exit procedure 370 thus makes it possible to warn the pilot of the impossibility to calculate a route with the current parameters, and to allow them to take appropriate measures to correct this problem.

FIGS. 4b to 4i show the diffusion of the interest in the situation shown in FIG. 4a. As explained above, the interest is diffused, in each iteration, and for each cell, as a weighted sum of the interests of the cells in an immediate neighbourhood in the preceding iteration. FIGS. 4b, 4c, 4d, 4e, 4f, 4g and 4h show, in order, the diffusion of the interest in the seven first iterations of diffusion. The regions 450b, 450c, 450d, 450e, 450f, 450g and 450h correspond, respectively, to the cells having a non-zero interest in each iteration.

FIG. 4i shows the diffusion of the interest at the moment when the interest reaches the position of the aircraft. The cells for which the interest is non-zero are denoted by 450i. In this example, the interest has reached the position 410 of the aircraft, the stop criterion is then satisfied in step 350, and the iterations of diffusion cease.

Once the interest has reached the position 410 of the aircraft, it is possible to determine a shorter path between the aircraft and the target position. In one set of embodiments of the invention, this shorter path is determined using a “ray-tracing” method. The region 460 corresponds to the region assigned by the ray tracing, which will be described in detail with reference to FIG. 4j.

In the case that the checking 360 of the interest at the position of the aircraft is positive, i.e. if the diffusion of the interest has been able to reach the position of the aircraft, a step 380 of iteratively determining the waypoints is activated.

This step consists in determining a list of waypoints defined by cells that have the most favourable interest levels for which a straight line plotted between two successive points on the list does not cross any cell whose absorption coefficient does not allow the cell to be crossed by the aircraft, i.e. a list, among the cells of region 460, of waypoints which allow the target point to be reached without intercepting a threat cell.

FIG. 4j shows one example of determining waypoints, using a “ray-tracing” method. This method consists in iteratively constructing a list of waypoints, each waypoint being identified by a cell. In the example of FIG. 4j, the list is constructed on the basis of the position of the aircraft, but it would be entirely possible to invert the method and to construct the list of waypoints on the basis of the target position.

The list of waypoints is initialized with the position 410 of the aircraft. At this stage, the list of waypoints therefore comprises only the position cell of the aircraft: [410].

The next cell to be added to the list will be chosen by iteratively determining candidate cells in the environment of the current cell that exhibit the highest interest, i.e. cells located on the “best” path: the shortest path and/or that which does not intercept any threat cells. In the example of FIG. 4j, a von Neumann neighbourhood will be used, but, in other embodiments of the invention, other types of neighbourhoods may be used.

A first candidate cell 4001 is identified: it is a cell in the von Neumann environment of the cell 410 having the highest interest. Since this cell is adjacent to the cell 410, the question of intercepting a threat cell is not yet relevant.

A second candidate cell 4002 is selected as the cell in the von Neumann neighbourhood of the first candidate cell 4001 that exhibits the highest interest. Next, a virtual line is plotted between the second candidate cell 4002 and the last cell on the list of waypoints (hence cell 410), in order to check whether a threat cell is intercepted. As long as this is not the case, the second candidate cell becomes the first, and a new second candidate cell is chosen as the cell in the neighbourhood of Von Neumann of the first that exhibits the highest interest, and then a virtual line is plotted up to cell 410 in order to check for the presence of threat cells, etc.

Thus, iteratively, the candidate cells 4003, 4004, 4005, 4006 are successively tested, without the lines between each of these cells and the cell 410 intercepting a threat cell.

Next, the cell 4007, which is the cell in the von Neumann neighbourhood of the cell 4006 that exhibits the highest interest, is tested. However, in this case, the straight line between cell 4007 and cell 410 intercepts threat cells, for example cell 4008. When such a configuration is encountered, it is the preceding candidate cell, here cell 4006, which is chosen as the next waypoint. The list of waypoints is therefore, at this stage, defined by the cells [410, 4006]. This method therefore makes it possible to define, between each waypoint, the largest possible flight segment which does not intercept any threat cells, keeping the last candidate cell for which the route will not intercept any threat cells. This makes it possible to obtain an optimal route with a number of waypoints and of segments that is as small as possible, which makes it possible to observe the maximum number of waypoints that the FMS expects as input.

New candidate cells are then tested for the next waypoint on the basis of the last point added to the list, i.e. cell 4006. The cells tested are, in a first instance, cells 4007, 4010, 4011 . . . up to cell 4012. Each time, the segment between cells 4006 and 4007, 4010, 4011 . . . 4012 on the one hand, and cell 4006 on the other hand, does not intercept a threat cell. At this stage, the candidate cells are selected from the same column, since it is the path for which the interest associated with each cell is maximum. However, after cell 4012, it will be cell 4013 which will be retained as the candidate cell. Specifically, it is associated with a higher interest level than cell 4014, which is located further from the diffusing agents located in the incisions of the ellipse 440, and has therefore experienced a less substantial diffusion of the interest. Next, the candidate cells 4015, 4016 . . . 4017 are tested. Here again, none of the segments between these cells and cell 4006 intercepts a threat agent.

Once the candidate cell 4017 has been tested, the von Neumann neighbourhood of the cell 4017 is evaluated in order to determine the next candidate cell. However, this neighbourhood comprises at least one transmitting agent, cell 4018 located in the incision of the ellipse 440. This means that the target region has been reached. Cell 4017 is therefore added to the list of candidates, along with target cell 420. The list of waypoints to be sent to the FMS is therefore composed of the following cells: [410 4006; 4017 420]. This list therefore comprises the minimum number of waypoints allowing the shortest possible trajectory to be flown between the position of the aircraft and the target position, while observing the constraints set, in this instance the angles of departure of the aircraft and of arrival at the target point.

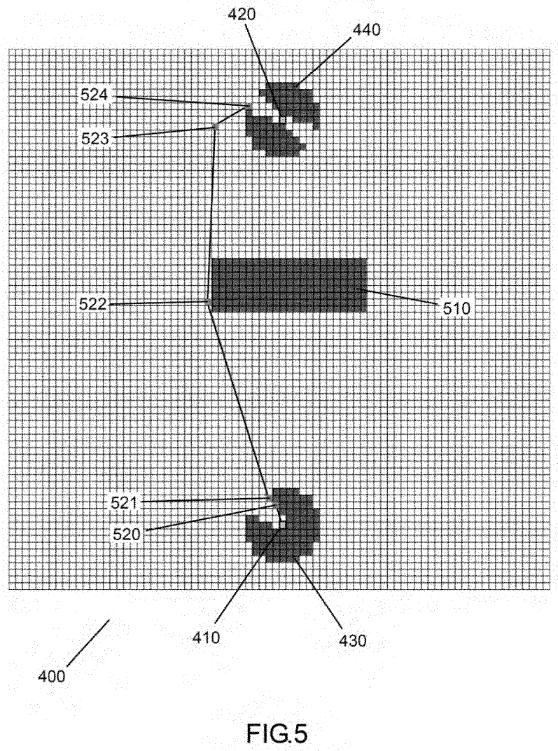

FIG. 5 shows an exemplary aircraft route calculated in one implementation of the invention.

The situation is here similar to that of FIG. 4a, except that an obstacle 510 has been added. This obstacle is associated with diffusion coefficients of zero. It is therefore strictly impossible for the interest to diffuse into it, and for the aircraft to cross it. In this example, the method 300 will select the waypoints and will extract the following list therefrom: [410, 520, 521, 522, 523, 524, 420]. It should be noted that here, the approach to the target point is made via the left-hand incision and not the right-hand incision. Specifically, the shape of the obstacle 510 has made the diffusion of the interest longer on the right in order to bypass it. The interest has therefore diffused faster across the cells to the left of the obstacle, which has led to waypoints bypassing the obstacle on the left being chosen.

This example demonstrates the ability of the invention to model constraints corresponding to different operational situations, and to select the shortest path to go from the position of the aircraft to the target point in all cases.

Once the list of waypoints has been determined in step 380, the method 300 comprises a step 390 of sending the waypoints to the FMS.

Upon completion of step 380, an optimal route has been identified, in the form of a list of cells. For sending to the FMS, the waypoints may be converted from cell coordinates to georeferenced coordinates accepted by the FMS.

According to various embodiments of the invention, each cell may be converted into a georeferenced position of a point in the cell. For example, in embodiments in which the latitude and longitude of each corner of a cell are known, a cell may be converted into a georeferenced position by performing a linear interpolation on the coordinates of the corners of the cell, i.e. the latitude and longitude of the point to be sent to the FMS are calculated, respectively, as the mean of the latitudes and longitudes of the four corners of the cell.

Thus, the step 390 may consist in converting the list of cells defining the route of the aircraft into a list of georeferenced positions, then in sending these positions to the FMS.

As mentioned above, the method according to the invention makes it possible to obtain a route that comprises the smallest possible number of waypoints observing the operational constraints. Thus, in the case that such a route exists, the route sent to the FMS will be accepted thereby, since the number of waypoints will be sufficiently small, and the spacing between the waypoints as large as possible.

Once the route has been sent to the FMS, it will be able to process it in order to convert it into a trajectory, and send suitable instructions to an autopilot and/or to display the trajectory to the pilot of the aircraft in order to follow the trajectory.

In one set of embodiments of the invention, the route may be recalculated later. For example, the route may be recalculated periodically, for example every 30 seconds, or when the distance between the aircraft and the target becomes shorter than a distance threshold.

Recalculating the trajectory makes it possible to update the predictions according to the changing position of the aircraft, but also, where appropriate, the position of the target point if it is mobile, and of regions to avoid (for example, in the case of regions of dangerous weather moving).

Recalculating the trajectory also makes it possible, when the route is calculated with grids of fixed size (for example 100×100 cells), to recalculate it with greater accuracy. Specifically, when the size of the grid is fixed, the resolution of the cells will increase with decreasing distance between the aircraft and the target point.

Thus, periodically recalculating the route with a fixed grid size makes it possible to calculate the route with a limited and determinate time (since the computing time is generally proportional to the number of cells), while benefitting from an accuracy of calculation that is as high as necessary as the target point is approached.

The invention has been described above for cases of calculating a route for an aircraft to a single target point, in two dimensions. However, the invention is not restricted to these examples.

For example, the invention may be extended to calculating a route in 3D. In this case, it is sufficient to define the environment of the aircraft and of the target point in the form of a 3D grid, with various altitude levels, to define the regions of regions to avoid according to the cells in three dimensions, to propagate interest in 3D, and to convert the positions of the 3D cells into a list of coordinates (latitude, longitude, altitude) to be sent to the FMS.

The invention is also applicable to route calculations from a plurality of aircraft, or to a plurality of targets: the interest may be propagated from a plurality of targets, and/or to reach a plurality of aircraft. If a plurality of aircraft are used, the aircraft to which the interest has propagated first, or the aircraft for which the interest level is highest in a given iteration of propagation, may be used for the mission. In this case, the method makes it possible to automatically select the aircraft best placed for accomplishing the mission. In the case that a plurality of targets are used, tracking from the aircraft with the highest interest makes it possible to return to the target that has diffused the interest in the most direct manner, and hence the target for which the best route is available. In one set of embodiments of the invention, the interest may be diffused from a plurality of targets, and a route calculated as soon as the interest has been propagated up to one aircraft at least.

The above examples demonstrate the capability of the invention to calculate an optimal route for an aircraft. These examples are however given only by way of example and in no way limit the scope of the invention, which is defined in the claims below.

1. A method for determining a route of an aircraft towards a target point in the environment of the aircraft, comprising:
obtaining at least one grid representing the environment of the aircraft, a position cell of the aircraft and a position cell of the target point in the grid, the at least one grid storing, for each cell, the georeferenced positions of the four corners of the cell, an absorption coefficient defining the possibility of a trajectory of the aircraft for crossing the cells, and an interest level defining the interest for the aircraft to select a cell to reach the target point;
defining, for a set of cells of the at least one grid, absorption coefficients between zero and one defining the possibility of a trajectory of the aircraft for crossing the cells, according to at least one element chosen from a set of regions to avoid, trajectory initialization constraints and approach constraints;
defining, for at least one cell around the target point, an interest level equal to a predefined interest threshold, and a lower interest level for the other cells of the grid;
a plurality of iterations, until a stop criterion is satisfied, of assigning, to each cell of the grid except said at least one cell around the target point, an interest level, equal to a weighted average of interest levels of cells in a neighbourhood of said cell, multiplied by a value equal to one minus the absorption coefficient for the cells of said set;
if, upon satisfying the stop criterion, the interest level of the position cell of the aircraft is zero, activating an exit procedure;
otherwise, iteratively determining a list of routing points defined by the cells having the most favourable interest levels for which a straight line plotted between two successive points on the list does not cross any cell whose absorption coefficient does not allow the cell to be crossed by the aircraft;
sending the list of routing points to a flight management system.

2. The method according to claim 1, wherein the grid is constructed following a rhumb line.

3. The method according to claim 1, wherein the grid has a predefined size, and the position cells of the aircraft and the position cell of the target point have predefined positions on the grid, said method comprising a step of associating, with each cell, georeferenced coordinates according to said predefined size and positions.

4. The method according to claim 1, wherein defining, for a set of cells of the at least one grid, absorption coefficients that define the possibility of a trajectory of the aircraft for crossing the cells, comprises defining, around the position of the aircraft, an ellipse of cells according to a maximum angle of curvature of the aircraft exhibiting an absorption coefficient that prevents the diffusion of the interest into the set of cells which is incised in the direction of movement or of takeoff of the aircraft.

5. The method according to claim 1, wherein defining absorption coefficients comprises defining, around the position of the target point, an ellipse of cells exhibiting an absorption coefficient that is higher than or equal to a predefined threshold, in which at least one incision is made in the direction of at least one sector of incidence for approaching the target point.

6. The method according to claim 5, wherein the at least one cell around the target point, for which an interest level is defined that is equal to a predefined interest threshold, comprises all of the cells of the at least one incision.

7. The method according to claim 1, wherein defining absorption coefficients comprises defining, for a set of cells of which at least one of the corners is located in a region to be avoided, an absorption coefficient that is higher than or equal to a predefined threshold.

8. The method according to claim 1, wherein the stop criterion is satisfied if at least one condition is met from among the following conditions:
the interest level of the position cell of the aircraft is higher than zero;
the number of iterations performed is smaller than or equal to a predefined maximum iteration threshold.

9. The method according to claim 1, wherein the operation of iteratively determining a list of routing points is performed by initializing the list with the position of the aircraft and, while the at least one cell around the target point has not been reached, determining a next point, on the basis of the current routing point on the list, by:
making a selection of a first candidate cell as the cell in the neighbourhood of the current routing point exhibiting the most favourable interest level;
selecting a second candidate cell as the cell in the neighbourhood of the first candidate cell exhibiting the most favourable interest level;
checking for the presence of a cell that cannot be crossed by the aircraft between the second candidate cell and the current routing point;
if a cell that cannot be crossed by the aircraft is present between the second candidate cell and the current routing point:
adding the first candidate cell to the list as the current routing point;
returning to selecting the first candidate cell;
if no cell that cannot be crossed by the aircraft is present between the second candidate cell and the current routing point:
replacing the first candidate cell with the second candidate cell;
returning to the step of selecting a second candidate cell.

10. The method according to claim 1, wherein the operation of sending the list of routing points to the flight management system comprises:
converting the list of routing points defined by cells in a list of georeferenced positions obtained, respectively, through linear interpolation of the georeferenced positions of the corners of the cells;
sending the list of georeferenced positions to the flight management system.

11. A computer program comprising program code instructions stored on a computer-readable medium for determining a route of an aircraft towards a target point in the environment of the aircraft when said program is run on a computer, said program code instructions being configured for:
obtaining at least one grid representing the environment of the aircraft, a position cell of the aircraft and a position cell of the target point in the grid, the at least one grid storing, for each cell, the georeferenced positions of the four corners of the cell, an absorption coefficient between zero and one defining the possibility of a trajectory of the aircraft for crossing the cells, and an interest level defining the interest for the aircraft to select a cell to reach the target point;
defining, for a set of cells of the at least one grid, absorption coefficients defining the possibility of a trajectory of the aircraft for crossing the cells, according to at least one element chosen from a set of regions to avoid, trajectory initialization constraints and approach constraints;
defining, for at least one cell around the target point, an interest level equal to a predefined interest threshold, and a lower interest level for the other cells of the grid;
performing a plurality of iterations, until a stop criterion is satisfied, of assigning, to each cell of the grid except said at least one cell around the target point, an interest level, equal to a weighted average of interest levels of cells in a neighbourhood of said cell, multiplied by a value equal to one minus the absorption coefficient for the cells of said set;
if, upon satisfying the stop criterion, the interest level of the position cell of the aircraft is zero, activating an exit procedure;
otherwise, iteratively determining a list of routing points defined by the cells having the most favourable interest levels for which a straight line plotted between two successive points on the list does not cross any cell whose absorption coefficient does not allow the cell to be crossed by the aircraft;
sending the list of routing points to a flight management system.

12. A system for managing a mission of an aircraft comprising computing means for determining a route of the aircraft towards a target point in the environment of the aircraft, said computing means being configured for:
obtaining at least one grid representing the environment of the aircraft, a position cell of the aircraft and a position cell of the target point in the grid, the at least one grid storing, for each cell, the georeferenced positions of the four corners of the cell, an absorption coefficient between zero and one defining the possibility of a trajectory of the aircraft for crossing the cells, and an interest level defining the interest for the aircraft to select a cell to reach the target point;
defining, for a set of cells of the at least one grid, absorption coefficients defining the possibility of a trajectory of the aircraft for crossing the cells, according to at least one element chosen from a set of regions to avoid, trajectory initialization constraints and approach constraints;
defining, for at least one cell around the target point, an interest level equal to a predefined interest threshold, and a lower interest level for the other cells of the grid;
performing a plurality of iterations, until a stop criterion is satisfied, of assigning, to each cell of the grid except said at least one cell around the target point, an interest level, equal to a weighted average of interest levels of cells in a neighbourhood of said cell, multiplied by a value equal to one minus the absorption coefficient for the cells of said set;
if, upon satisfying the stop criterion, the interest level of the position cell of the aircraft is zero, activating an exit procedure;
otherwise, iteratively determining a list of routing points defined by the cells having the most favourable interest levels for which a straight line plotted between two successive points on the list does not cross any cell whose absorption coefficient does not allow the cell to be crossed by the aircraft;
sending the list of routing points to a flight management system.
